(19) United States
(12) Patent Application Publication
(10) Pub. No.: US 2014/0268492 A1
(43) Pub. Date: Sep. 18, 2014

(54) BARIUM CALCIUM TIN TITANATE POWDER, DIELECTRIC COMPOSITION AND MULTILAYER CERAMIC CAPACITOR

(71) Applicant: SAMSUNG ELECTRO-MECHANICS CO., LTD., Suwon (KR)

(72) Inventors: Han Soung JEONG, Suwon (KR); Doo Yeon HWANG, Suwon (KR); Chang Hoon KIM, Suwon (KR); Sun Ho YOON, Suwon (KR); Seok Hyun YOON, Suwon (KR); Hyo Jung KIM, Suwon (KR)

(73) Assignee: SAMSUNG ELECTRO-MECHANICS CO., LTD.

(21) Appl. No.: 13/931,663

(22) Filed: Jun. 28, 2013

(30) Foreign Application Priority Data
Mar. 14, 2013 (KR) 10-2013-0027533

(51) Int. Cl. H01G 4/12

(52) U.S. Cl. CPC H01G 4/1227
USPC 361/321.4; 501/137; 428/402

(57) ABSTRACT

There is provided a dielectric composition containing barium calcium tin titanate powder composed of (Ba_{(1-x-y)}CaₓSn_{y})_{z}TiO₃, satisfying 0.01≦x≦0.15, 0.01≦y≦0.20, and 0.99≦z≦1.01.

### CROSS-REFERENCE TO RELATED APPLICATIONS

This application claims the priority of Korean Patent Application No. 10-2013-0027533 filed on Mar. 14, 2013, in the Korean Intellectual Property Office, the disclosure of which is incorporated herein by reference.

### BACKGROUND OF THE INVENTION

1. Field of the Invention

The present invention relates to a barium calcium tin titanate powder having excellent high temperature characteristics, a dielectric composition containing the same, and a multilayer ceramic capacitor using the dielectric composition.

2. Description of the Related Art

In general, electronic components using a ceramic material, such as a capacitor, an inductor, a piezoelectric device, a varistor, a thermistor, or the like, include a ceramic body formed of a ceramic material, internal electrodes formed within the ceramic body, and external electrodes installed on surfaces of the ceramic body so as to be connected to the internal electrodes.

Among ceramic electronic components, a multilayer ceramic capacitor includes a plurality of stacked dielectric layers, internal electrodes disposed to face each other, having the dielectric layer interposed therebetween, and external electrodes electrically connected to the internal electrodes.

The multilayer ceramic capacitor has been widely used as a component for in mobile communication devices such as computers, personal data assistants (PDAs), mobile phones, or the like, due to advantages thereof such as a small size, high capacitance, easiness of mounting, or the like.

The multilayer ceramic capacitor is manufactured by stacking conductive paste layers for an internal electrode and a dielectric paste in a sheet method, a printing method, or the like, and simultaneously firing the multilayered paste layers.

Electrical features of the multilayer ceramic capacitor are changed according to the type of dielectric powder contained in the dielectric paste and the features thereof.

Therefore, in order to manufacture a multilayer ceramic capacitor having a high degree of reliability, a dielectric composition having high permittivity and excellent high temperature characteristics is required.

In the case of the existing barium titanate powder used in a multilayer ceramic capacitor, a phase transition temperature at which a tetragonal barium titanate powder is converted into a cubic barium titanate powder is about 125° C., and when the temperature rises to 125° C. or more, the permittivity may be rapidly decreased.

Therefore, in order to provide a multilayer ceramic capacitor capable of being used at a high temperature, the development of high crystallinity powder of which a phase-transition temperature from a tetragonal structure into a cubic structure is increased has been demanded.

Dielectric powders in which calcium (Ca) is substituted at a barium site in barium titanate and zirconium (Zr) is substituted at a titanium (Ti) site in barium titanate are disclosed in Patent Document 1 of the following Related Art Documents, and a dielectric powder in which tin (Sn) is substituted at a titanium (Ti) site in barium titanate is disclosed in Patent Document 2. However, a dielectric powder in which calcium (Ca) and tin (Sn) are substituted at the barium (Ba) site is not disclosed in the following Patent Documents 1 and 2.

### RELATED ART DOCUMENT

(Patent Document 1) Korean Patent Laid-Open Publication No. 10-2008-0073174
(Patent Document 2) Korean Patent Laid-Open Publication No. 10-2005-0054591

### SUMMARY OF THE INVENTION

An aspect of the present invention provides barium calcium tin titanate powder having excellent high temperature characteristics, a dielectric composition containing the same, and a multilayer ceramic capacitor using the dielectric composition.

According to an aspect of the present invention, there is provided a dielectric composition containing barium calcium tin titanate powder composed of (Ba_{(1-x-y)}CaₓSn_{y})_{z}TiO₃, satisfying 0.01≦x≦0.15, 0.01≦y≦0.20, and 0.99≦z≦1.01.

c/a, a ratio of length in a c-axis of a crystal structure to length in an a-axis thereof, of the barium calcium tin titanate powder may be 1.0105 or more.

The barium calcium tin titanate powder may have a specific surface area of 1 to 3 m²/g.

A phase-transition temperature, a temperature at which a crystal structure is converted from a tetragonal structure into a cubic structure, of the barium calcium tin titanate may be higher than that of barium titanate (BaTiO₃) by 6° C. or more.

The dielectric composition may further contain at least one secondary component selected from a group consisting of silicon (Si) and titanium (Ti).

The barium calcium tin titanate powder may be prepared by a solid-phase synthesis method.

According to an aspect of the present invention, there is provided a multilayer ceramic capacitor including: a ceramic body including a dielectric layer; first and second internal electrodes disposed in the ceramic body so as to face each other, having the dielectric layer interposed therebetween; a first external electrode electrically connected to the first internal electrode; and a second external electrode electrically connected to the second internal electrode, wherein the dielectric layer contains barium calcium tin titanate composed of (Ba_{(1-x-y)}CaₓSn_{y})_{z}TiO₃, satisfying 0.01≦x≦0.15, 0.01≦y≦0.20, and 0.99≦z≦1.01.

c/a, a ratio of length in a c-axis of a crystal structure to length in an a-axis thereof, of the barium calcium tin titanate powder may be 1.0105 or more.

A phase-transition temperature, a temperature at which a crystal structure is converted from a tetragonal structure into a cubic structure, of the barium calcium tin titanate may be higher than that of barium titanate (BaTiO₃) by 6° C. or more.

The dielectric layer may further contain at least one secondary component selected from a group consisting of silicon (Si) and titanium (Ti).

According to an aspect of the present invention, there is provided a barium calcium tin titanate powder composed of (Ba_{(1-x-y)}CaₓSn_{y})_{z}TiO₃, satisfying 0.01≦x≦0.15, 0.01≦y≦0.20, and 0.99≦z≦1.01.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line A-A′ of FIG. 1;

FIG. 3 is a scanning electronic microscope (SEM) photograph of barium calcium tin titanate powder according to the embodiment of the present invention;

FIG. 4 is a graph showing results obtained by X-ray diffraction (XRD) analysis of the barium calcium tin titanate powder according to the embodiment of the present invention and barium titanate powder; and

FIG. 5 is a graph showing a change in capacitance according to the temperature in the barium calcium tin titanate powder according to the embodiment of the present invention and barium titanate powder.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

FIG. 1 is a perspective view schematically showing a multilayer ceramic capacitor according to an embodiment of the present invention.

FIG. 2 is a cross-sectional view taken along line A-A′ of FIG. 1.

Hereinafter, the multilayer ceramic capacitor will be described by way of example, but the present invention is not limited thereto.

Referring to FIGS. 1 and 2, the multilayer ceramic capacitor 100 according to the embodiment of the present invention may include a ceramic body 110; and first and second external electrodes 131 and 132.

As shown in FIG. 2, the exploded perspective view of the ceramic body 110, the ceramic body 110 may include a plurality of dielectric layers 111 and the first and second internal electrodes 121 and 122 formed on the dielectric layers 111, and may be formed by stacking the plurality of dielectric layers having the internal electrode formed thereon. In addition, the first and second internal electrodes may be disposed so as to face each other, having a dielectric layer 111 interposed therebetween.

According to the embodiment of the present invention, the plurality of dielectric layers 111 configuring the ceramic body 110 may be in a sintered state and may be integrated with each other such that a boundary between dielectric layers adjacent to each other may not be readily apparent without the use of a scanning electron microscope.

The dielectric layer 111 may be formed of a dielectric composition containing barium calcium tin titanate powder composed of (Ba_{(1-x-y)}CaₓSn_{y})_{z}TiO₃, satisfying 0.01≦0.15, 0.01≦y≦0.20, and 0.99≦z≦1.01.

In the case in which x is less than 0.01, Sn of the powder may not be substituted at an A site (Ba site) of barium titanate, and in the case in which x is greater than 0.15, Ca may exceed a solubility limit of the A site to thereby be substituted at a B site (Ti site). As a result, c/a of a crystal structure of a dielectric material is rather decreased.

When y is less than 0.01, a phase-transition temperature is not increased, and when y is greater than 0.2, Ca is also substituted at the B site, such that the phase-transition temperature is rather decreased.

When z is less than 0.99, abnormal particle growth may be easily generated, and when z is greater than 1.01, a firing temperature is increased, such that particle growth may be difficult.

In the case of barium calcium tin titanate in which Ca and Sn are substituted at the A site (Ba site) of barium titanate (BaTiO₃), crystallinity is increased as compared with pure barium titanate, such that the phase-transition temperature, that is, a temperature at which a crystal structure of a dielectric material having a perovskite structure is converted from a tetragonal structure into a cubic structure may be increased.

The barium calcium tin titanate powder may have a phase-transition temperature higher than that of pure barium titanate powder by 6° C. or more.

In a dielectric material having a perovskite structure and used in a dielectric layer of the multilayer ceramic capacitor, as a crystal structure is changed at a phase-transition temperature, capacitance is changed, and in the case in which tetragonal dielectric material is changed to a cubic dielectric material due to a temperature increase, permittivity may be rapidly decreased. Therefore, in the case of applying barium calcium tin titanate having a phase-transition temperature increased as compared with the existing barium titanate (BaTiO₃) to the dielectric layer, the multilayer ceramic capacitor capable of operating at a high temperature may be provided.

The barium calcium tin titanate powder may have of 1.0105 or more in c/a, wherein c/a is a ratio of length in a c-axis of the crystal structure to length in an a-axis thereof. As the c/a value becomes larger than 1, the length of a long axis becomes longer than length in a short axis in the tetragonal structure, which means that transition from the tetragonal structure into the cubic structure may be problematic. Therefore, in order to covert the tetragonal structure into the cubic structure, since a large amount of energy needs to be used, the phase-transition temperature is increased.

In addition, the barium calcium tin titanate powder may have a specific surface area of 1 to 3 m²/g. In the case in which the specific surface area of the barium calcium tin titanate powder is less than 1 m²/g, the firing temperature of the dielectric material may be increased, and in the case in which the specific surface area is greater than 3 m²/g, the permittivity may be decreased.

Further, the barium calcium tin titanate powder may be prepared by a solid-phase synthesis method, and a detailed description thereof will be described in the Examples. It is known that in the case of preparing barium titanate by the solid-phase synthesis method, barium titanate may be mass-produced, but it is difficult to prepare uniform fine powder. However, according to embodiments of the present invention, even in the case of using the solid-phase synthesis method, barium calcium tin titanate powder having a uniform particle-size distribution at a level of 400 nm may be obtained.

The dielectric composition is not particularly limited, but may further contain at least one secondary component selected from a group consisting of silicon (Si) and titanium (Ti) as an additive, and further contain an element selected from a group consisting of cesium (Ce), niobium (Nb), lanthanum (La), antimony (Sb), silicon (Si), barium (Ba), calcium (Ca), and aluminum (Al), an oxide thereof, a carbonate thereof, or mixture thereof, in order to implement the required characteristics.

The dielectric composition may further contain a dispersant, a solvent, and an organic binder and be coated in a form of ceramic slurry, thereby forming a ceramic green sheet.

The dielectric layer may be formed by firing the above-mentioned ceramic green sheet.

According to the embodiment of the present invention, the first and second internal electrodes may be formed of a conductive paste containing a conductive metal. The conductive metal may be nickel (Ni), copper (Cu), palladium (Pd), or an alloy thereof, but is not limited thereto.

The internal electrode may be printed on the ceramic green sheet forming the dielectric layer using a conductive paste through a printing method such as a screen printing method or a gravure printing method, but is not limited thereto. The ceramic green sheets having the internal electrode printed thereon may be alternately stacked and fired to form the ceramic body 110.

Next, the first and second external electrodes 131 and 132 may be formed so as to be electrically connected to the first and second internal electrodes, respectively. The first and second external electrodes 131 and 132 may contain a conductive metal, wherein the conductive metal may be nickel (Ni), copper (Cu), tin (Sn), or an alloy thereof, but is not limited thereto.

The dielectric layer 111 of the multilayer ceramic capacitor 100 manufactured as described above may contain barium calcium tin titanate powder composed of (Ba_{(1-x-y)}CaₓSn_{y})_{z}TiO₃, satisfying 0.01≦x≦0.15, 0.01≦y≦0.20, and 0.99≦z≦1.01.

Further, the dielectric layer 111 is not particularly limited, but may further contain at least one secondary component selected from a group consisting of silicon (Si) and titanium (Ti) as an additive, and further contain an element selected from a group consisting of cesium (Ce), niobium (Nb), lanthanum (La), antimony (Sb), silicon (Si), barium (Ba), calcium (Ca), and aluminum (Al), an oxide thereof, a carbonate thereof, or mixture thereof.

Contents overlapped with the description of the dielectric composition according to the embodiment of the present invention in a description of the multilayer ceramic capacitor according to the present embodiment will be omitted.

According to the embodiment of the present invention, dielectric powder having excellent crystallinity and a high phase-transition temperature and the dielectric composition including the dielectric powder may be provided, and the multilayer ceramic electronic component to which the dielectric powder is applied and of which high-temperature reliability is excellent may be provided.

### EXPERIMENTAL EXAMPLE

A mixed powder obtained by weighing titanium oxide having a specific surface area of 5 to 15 m²/g, barium carbonate having a specific surface area of 2 to 10 m²/g, calcium carbonate having a specific surface area of 2 to 10 m²/g, and tin oxide having a specific surface area of 2 to 10 m²/g so that a molar ratio of Ba:Ca:Sn:Ti is 0.9:0.1:0.1:1 was mixed in a pure solvent together with a dispersant.

The mixing was performed using a bead mill to which beads having an average particle size of 0.1 mm or less and a casting speed of the bead mill was 8 m/s or more were applied, thereby obtaining the mixed powder having a specific surface area of 15 m²/g or more.

After the mixed powder was dried, the dried powder was calcined by smoothly discharging carbon dioxide into the air and then finely ground, thereby obtaining barium calcium tin titanate powder.

FIG. 3 is a scanning electronic microscope (SEM) photograph of barium calcium tin titanate powder prepared using the above-mentioned method. As shown in FIG. 3, it may be appreciated that the powder had uniform particle-size distribution even when the powder was prepared using the solid-phase synthesis method.

FIG. 4 is a graph showing results obtained by X-ray diffraction (XRD) analysis of the barium calcium tin titanate powder prepared by the above-mentioned method and pure barium titanate powder.

In the results of the XRD analysis of FIG. 4, graphs of the barium calcium tin titanate powder and pure barium titanate powder have two peaks, respectively. The wider the interval between the peaks, the higher the crystallinity of the tetragonal crystal structure.

In the graphs, an interval between two peaks of the pure barium titanate is represented as d1, and an interval between two peaks of the barium calcium tin titanate powder of Experimental Example is represented as d2, and it may be appreciated that d2 is larger than d1.

That is, it may be appreciated that a c/a value of the barium calcium tin titanate powder of Experimental Example was larger than that of the pure barium titanate powder. Specific c/a values thereof were shown in Table 1.

TABLE 1

| | Barium calcium tin titanate | Barium titanate |
|---|---|---|
| a | 3.97487 | 3.98967 |
| c | 4.01721 | 4.02787 |
| c/a | 1.010651921 | 1.009574727 |

FIG. 5 is a graph showing a change in capacitance according to the temperature in the barium calcium tin titanate powder prepared by the above-mentioned method and pure barium titanate powder.

In more detail, FIG. 5 is a graph showing a change in capacitance due to a change in the crystal structure at the phase-transition temperature.

A peak of the graph indicates a phase-transition temperature, and it may be appreciated that the barium calcium tin titanate powder of Experimental Example has a phase-transition temperature higher than that of the pure barium titanate by about 6° C.

Therefore, in the case in which the barium calcium tin titanate powder of Experimental Example is applied to the multilayer ceramic electronic component, the phase-transition temperature is increased, such that high temperature reliability may be improved.

As set forth above, according to embodiments of the present invention, barium calcium tin titanate powder having excellent high temperature characteristics, a dielectric composition containing the same, and a multilayer ceramic capacitor using the dielectric composition may be provided.

While the present invention has been shown and described in connection with the embodiments, it will be apparent to those skilled in the art that modifications and variations can be made without departing from the spirit and scope of the invention as defined by the appended claims.

What is claimed is:

1. A dielectric composition comprising barium calcium tin titanate powder composed of (Ba_{(1-x-y)}CaₓSn_{y})_{z}TiO₃, satisfying 0.01≦x≦0.15, 0.01≦y≦0.20, and 0.99≦z≦1.01.

2. The dielectric composition of claim 1, wherein c/a, a ratio of length in a c-axis of a crystal structure to length in an a-axis thereof, of the barium calcium tin titanate powder is 1.0105 or more.

3. The dielectric composition of claim 1, wherein the barium calcium tin titanate powder has a specific surface area of 1 to 3 m²/g.

4. The dielectric composition of claim 1, wherein a phase-transition temperature, a temperature at which a crystal structure is converted from a tetragonal structure into a cubic structure, of the barium calcium tin titanate powder is higher than that of barium titanate (BaTiO₃) powder by 6° C. or more.

5. The dielectric composition of claim 1, further comprising at least one secondary component selected from a group consisting of silicon (Si) and titanium (Ti).

6. The dielectric composition of claim 1, wherein the barium calcium tin titanate powder is prepared by a solid-phase synthesis method.

7. A multilayer ceramic capacitor comprising:
a ceramic body including a dielectric layer;
first and second internal electrodes disposed in the ceramic body so as to face each other, having the dielectric layer interposed therebetween;
a first external electrode electrically connected to the first internal electrode; and
a second external electrode electrically connected to the second internal electrode,
wherein the dielectric layer contains barium calcium tin titanate composed of (Ba_{(1-x-y)}CaₓSn_{y})_{z}TiO₃, satisfying 0.01≦x≦0.15, 0.01≦y≦0.20, and 0.99≦z≦1.01.

8. The multilayer ceramic capacitor of claim 7, wherein c/a, a ratio of length in a c-axis of a crystal structure to length in an a-axis thereof, of the barium calcium tin titanate powder is 1.0105 or more.

9. The multilayer ceramic capacitor of claim 7, wherein a phase-transition temperature, a temperature at which a crystal structure is converted from a tetragonal structure into a cubic structure, of the barium calcium tin titanate is higher than that of barium titanate (BaTiO₃) by 6° C. or more.

10. The multilayer ceramic capacitor of claim. 7, wherein the dielectric layer further contains at least one secondary component selected from a group consisting of silicon (Si) and titanium (Ti).

11. A barium calcium tin titanate powder composed of (Ba_{(1-x-y)}CaₓSn_{y})_{z}TiO₃, satisfying 0.01≦x≦0.15, 0.01≦y≦0.20, and 0.99≦z≦1.01.
